(19) United States
(12) Patent Application Publication
(10) Pub. No.: US 2025/0263317 A1
(43) Pub. Date: Aug. 21, 2025

(54) Black Water Holding Tank Treatment and Method

(71) Applicant: ETN Capital, LLC, Sanford, NC (US)

(72) Inventor: Gary S. Huvard, Sanford, NC (US)

(21) Appl. No.: 18/581,053

(22) Filed: Feb. 19, 2024

(51) Int. Cl. C02F 1/68; C02F 101/10; C02F 103/00

(52) U.S. Cl. CPC C02F 1/683; C02F 2101/101; C02F 2103/005; C02F 2201/008; C02F 2303/02

(57) ABSTRACT

In-tank black water treatment compositions and methods of treating black water held in vehicle black water holding tanks in vehicles are disclosed at least for the purpose of reducing and/or eliminating the hydrogen sulfide concentration formed in a black water holding tank in a vehicle, and reducing and eliminating existing and generated hydrogen sulfide.

### TECHNOLOGICAL FIELD

The present disclosure relates, generally, to the field of black water holding tanks that can include vehicle black water holding tanks. More specifically, the present disclosure relates to the field of odor neutralization in recreational vehicle black water holding tanks.

### BACKGROUND

Many treatments available for odor neutralization in recreational vehicle (RV) wastewater holding tanks have limitations in terms of selected options that address odor neutralization and that also offer ecologically-friendly options for the disposal of treated wastewater from the holding tanks.

RVs typically have “gray water” or “black water” holding tanks (referred to equivalently herein as “wastewater holding tanks”) used to keep wastewater onboard a vehicle and confined within the tank until the wastes can be discarded from the tank as the tank is emptied, for example, at a campground, upon return to a residence, etc. Such waste accumulation within a wastewater holding tank can result in waste storage onboard a vehicle for a multi-day period (e.g., 3, 4, 5 days or more, etc.), and further including up to one or more weeks, etc. While gray water contains non-drinkable wastewater from sinks, showers, etc., black water contains human waste and is typically isolated and stored for periods of time in a separate black water holding tank in an RV. RV wastewater holding tanks can contain waste that is more concentrated than in, for example, residential sewage tanks, as less water or no water is delivered to the holding tank in an RV for the purpose of diluting accumulating waste, etc. As a result, until a black water holding tank can be emptied, at least for onboard comfort, odor neutralization of the accumulating waste in the black water holding tank is often desirable. Odor amelioration has been attempted and sometimes adequately realized through the addition of fragrant additives to the RV black water holding tank.

Even if commercially available RV holding tank black water treatments contain a mix of chemicals that claim to offer odor amelioration, such additives may contain hard metals or other compounds that form environmentally toxic or environmentally unfriendly products or by-products that, for example, can precipitate out of the wastewater, and/or that can form an environmentally unfriendly mixture that can complicate disposal and complicate identifying appropriate locations for disposal of the black water from the holding tanks. Even if certain chemical compounds are today approved for disposal into areas that could impact groundwater, etc., future regulatory changes could prohibit the release of compounds introduced as additives into and found in today's RV treated black water that is released into the environment from RV wastewater holding tanks.

In addition, many commercially available RV wastewater treatment options come to the consumer with little or no information regarding their actual contents, making it difficult or impossible for a typical consumer concerned about environmentally safe wastewater treatment disposal to know or be able to ascertain the true contents of additive treatments, the actual chemical mechanism being employed for odor neutralization, and/or the potential environmental impact or environmental harm of using a particular treatment (and disposing of wastewater that has been treated using such treatment) that may be, at least, ecologically unfriendly, if not environmentally harmful or otherwise toxic.

Unless explicitly identified as such, no statement herein is admitted as prior art merely by its inclusion in the Technological Field and/or Background section.

### SUMMARY

Present aspects are directed to compositions and methods for improving the treating of black water in a vehicle black water holding tank, with compositions directed to significantly reducing, and/or eliminating the odors from hydrogen sulfide in black water in a vehicle black water holding tank. Present compositions comprise constituents in compositions and composition mixtures directed to chemically neutralize and otherwise sequester existing hydrogen sulfide in black water. Optionally, present formulations can also significantly impede prospective formation of hydrogen sulfide by providing oxygen via an oxygen-releasing compound in the composition to alter, ameliorate, and impede bacterial hydrogen sulfide production in black water retained in a vehicle black water holding tank. The present compositions comprise ferric ion-releasing compounds along with amounts of citric acid that interacts with the black water to produce a significantly more environmentally-safe black water discharged from the black water holding tanks during black water disposal from the holding tank.

Present aspects are directed to a composition for treating black water and scavenging hydrogen sulfide from black water contained within a black water holding tank in a vehicle, with the composition including a ferric ion-releasing compound in an amount ranging from about 66 wt % to about 60 wt %, and citric acid in an amount ranging from about 34 wt % to about 40 wt %, wherein the composition is configured to scavenge hydrogen sulfide from black water in a vehicle black water holding tank.

In another aspect, the ferric-ion releasing compound and the citric acid are provided in the compound in a relative wt % ratio of 2:1.

In another aspect, the composition in solution is configured to maintain a pH ranging from about 3.0 to about 3.5 in solution in black water.

In another aspect, the composition in solution in black water in a black water holding tank solution further maintains a hydrogen sulfide concentration in black water ranging from about 5 ppm to about 10 ppm hydrogen sulfide when the black water holding tank solution maintains a pH ranging from about 3.0 to about 3.5.

In another aspect, the ferric ion-releasing compound includes at least one of ferric ammonium sulfate, ferric ammonium nitrate and ferric ammonium citrate.

In a further aspect, the ferric ion-releasing compound includes ferric ammonium citrate.

In another aspect, the composition is in an aqueous liquid mixture form.

In another aspect, the composition is a solid mixture.

In another aspect, the composition liquid form is encapsulated in a water soluble encapsulation.

In another aspect, the composition in solid mixture form is encapsulated in a water soluble encapsulation.

Present aspects are further directed to a pre-dosed treatment for scavenging hydrogen sulfide from black water contained within a black water holding tank in a vehicle, with the pre-dosed treatment comprising a pre-dosed amount of a black water treatment composition, with the black water treatment composition including a ferric ion-releasing compound in an amount ranging from about 66 wt % to about 60 wt %, and citric acid in an amount ranging from about 34 wt % to about 40 wt %.

In another aspect, in the pre-dosed treatment the ferric-ion releasing compound and the citric acid are provided in a relative wt % ratio of 2:1.

In another aspect, the pre-dosed treatment includes at least one of ferric ammonium sulfate, ferric ammonium nitrate, and ferric ammonium citrate.

In another aspect, the pre-dosed treatment includes ferric ammonium citrate.

In another aspect, the pre-dosed treatment includes a liquid composition

In another aspect, the pre-dosed treatment includes a solid composition.

In another aspect, the pre-dosed treatment the composition is in pellet form.

In a further aspect, the pre-dosed treatment includes a time-released composition.

In another aspect, the pre-dosed treatment further includes an encapsulated amount of the treatment composition.

In another aspect, the pre-dosed treatment encapsulated volume of the treatment composition is releasable from a water soluble encapsulation.

A further present aspect is directed to a method for treating wastewater in a recreational vehicle wastewater holding tank, with the method including adding to a vehicle black water holding tank containing black water a composition, with the composition including a ferric ion-releasing compound and citric acid. A method further includes adding additional amounts of citric acid to the black water holding tank to maintain a pH in the black water ranging from about 3.0 to about 3.5.

In another aspect, a method further includes adding an amount of the composition to the black water in the black water holding tank to maintain a hydrogen sulfide concentration in the black water ranging from about 5 ppm to about 10 ppm.

Another present aspect is directed to a method for pre-treating wastewater in a vehicle black water holding tank, with the method including pretreating a vehicle black water holding tank by adding an amount of a hydrogen sulfide scavenging composition to an empty vehicle black water holding tank, with the hydrogen sulfide scavenging composition including a ferric ion-releasing compound, and citric acid.

In another aspect, the hydrogen sulfide scavenging composition includes at least one of ferric ammonium sulfate, ferric ammonium nitrate, and ferric ammonium citrate.

In another aspect, the hydrogen sulfide scavenging composition includes ferric ammonium citrate.

In another aspect, the composition includes a ferric ion-releasing compound in an amount ranging from about 66 wt % to about 60 wt %, and citric acid in an amount ranging from about 34 wt % to about 40 wt %.

In another aspect, the ferric-ion releasing compound and the citric acid are provided to the composition in a relative wt % ratio of 2:1.

A further present aspect is directed to maintaining a hydrogen sulfide concentration in the black water holding tank ranging from about 5 ppm to about 10 ppm hydrogen sulfide.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is a flowchart outlining a method, according to present aspects;

FIG. 2 is a flowchart outlining a method, according to present aspects;

FIG. 3 is a flowchart outlining a method, according to present aspects; and

FIG. 4 is a flowchart outlining a method, according to present aspects.

### DETAILED DESCRIPTION

Present aspects are directed to the in-tank treatment of black water wastewater held in holding tanks in vehicles for the purpose of reducing and/or eliminating the hydrogen sulfide (H₂S) concentration formed in a holding tank in a vehicle that can be, for example, a terrestrial recreational vehicle, a marine vehicle, an aircraft, etc. The reduction and elimination of exiting H₂S, and the curtailment of future H₂S generation within black water holding tanks located in vehicles significantly reduces the highly odiferous component of black water contents found in vehicle black water holding tanks, including, for example RV black water holding tanks, etc.

According to present aspects, useful unexpected chemistry is newly applied to form and use ferric ion-releasing compounds as a source of ferric ions released from an environmentally-friendly composition mixture into a contained environment in a black water holding tank of a vehicle for the purpose of reducing and eliminating hydrogen sulfide present in the black water during, for example, a black water storage cycle. Optionally, present aspects are directed to impeding the formation cycle of additional or new H₂S that can be bacterially generated in the black water within the black water holding tank. According to further present aspects, present chemistries release ferric ions that can act to chemically convert the H₂S in the black water holding tank into non-odiferous compounds and produce black water that is at least environmentally-neutral or environmentally-friendly, with the stored black water not realizing an increase in toxicity due to chemical reactions occurring in black water treated with the present compositions and according to the present methods.

While not intending to be limited to the operation of chemical reactions and mechanisms occurring when the present compositions are presented into the solution of a black water holding tank containing black water, it is believed that the addition of ferric ions (Fe³⁺) from a ferric ion-releasing compound that can be a ferric ion precursor salt, etc. into black water eliminates or substantially eliminates (renders a H₂S concentration below about 10 ppm: a H₂S concentration level where an odor emanating from) H₂S presence and is not otherwise noticeable. In another example, the release of ferric ions from the present composition maintains a concentration of H₂S in the black water to a H₂S concentration ranging from about 5 ppm to about 10 ppm.

That is, within a relatively short period of time ranging from about 3 mins. to about 5 mins., the existing amount (e.g., concentration) of hydrogen sulfide (H₂S) within a black water solution in a black water holding tank treated with the present composition is essentially “neutralized” from the black water in a black water holding tank. Ferric ion-releasing compounds can include ferric ion-releasing precursor salts that can include, for example, ferric ammonium sulfate, ferric ammonium nitrate, and ferric ammonium citrate.

Present aspects are directed to the use and generation of the ferric ion (Fe³⁺) to interact with H₂S at least for the purpose of forming an environmentally-safe metal sulfide (that can precipitate as a solid in a black water solution) and neutralizing or “scavenging” the H₂S in black water in, for example, vehicle black water holding tanks. According to present aspects, the use of iron ions as the reactive ions is desirable and replaces the undesired previous use of other metals and other metal ions that have been used in black water treatment formulations (including, for example, zinc and/or zinc ions) that can render a resulting treated black water solution toxic, and that can significantly impact and frustrate the safe and environmentally-friendly disposal of, for example, zinc-treated black water.

Hydrogen sulfide can dissolve in aqueous solutions according to the following formula:

H₂S- - ->HS⁻+H⁺

While it is believed that a reaction of ferric ions with H₂S can impact the pH of the black water, present aspects contemplate augmenting the efficiency of the H₂S-savenging impact of the Fe³⁺ ions by adding citric acid to the composition and further dosing a black water holding tank with additional periodic selected and effective dosages of citric acid to maintain a black water pH in the acidic range of from about 3 to about 3.5.

While several intermediate reactions will occur as ferric ions are supplied to the black water from the ferric ion-releasing component in the present compositions, an overall approximate stoichiometry can be expressed as:

10Fe³⁺+5HS⁻+4H₂O- - ->7Fe²⁺SO₄²⁻+FeS₄+13H⁺

As stated herein, left unchecked, within a black water holding tank containing black water, additional H₂S can be generated, as bacteria present in human waste within the black water can generate further H₂S as a byproduct in an anerobic system. According to further present aspects, the present treatments can optionally include supplying at least one oxygen-generating compound such that selected amounts of oxygen are added to the black water in the holding tank as the added composition dissolves and reacts with the black water. The release or generation of additional oxygen can impact the black water to create an aerobic environment for bacteria present in the black water such that bacterial generation of additional H₂S in the treated black water is significantly impeded or terminated completely, while increasing the growth of digesting bacteria populations.

In one example, present compositions contemplate incorporating ferric ammonium citrate (FAC) as the ferric ion-generating or ferric ion-releasing compound. FAC is highly soluble in water, and is a complex formed from ferric iron, ammonia, and citric acid according to known reaction mechanisms, and with an amount of iron present in FAC equal to about 16 wt % to about 18 wt %.

Present experimentation has unexpectedly observed and discovered that the addition of citric acid to a composition, and the addition of an excess amount citric acid to FAC solutions results in the increased release of ferric ions into solution, with the solution remaining extremely stable for lengthy durations (e.g., a duration exceeding multiple days and extending up to multiple weeks).

“Stability”, at least for potassium thiocyanate (KSCN) testing purposes, is recognized as the iron remaining in the form of unsequestered or otherwise unattached ferric irons that react immediately in solution with KSCN to render a blood red color to a tested sample (and that is a characteristic indication of the presence of ferric ions). When exposed to light, ferric ions in solution convert to ferrous iron (Fe²⁺) that will not react well with H₂S. Present aspect contemplate retaining a high concentration of ferric ion (Fe³⁺) in solution for extended periods for the purpose of scavenging H₂S from the black water, through the inclusion of an effective amount of citric acid in the composition itself, as well as present methods of extending the useful life of the present H₂S-scavenging compositions by providing a regimen to supply excess amounts of additional citric acid to the black water tanks under treatment, and to maintain the black water volume within a black water holding tank at a pH ranging from about 3.0 to about 3.5.

According to further examples, present compositions and treatments further include amounts of compounds that will react to generate amounts of oxygen (referred to herein as oxygen-generating compounds) into the black water under treatment. Presently contemplated oxygen-generating compounds can include, for example, urea hydrogen peroxide (UHP), and sodium percarbonate. Urea hydrogen peroxide is a water soluble adduct of urea and hydrogen peroxide that will dissolve in the black water in the holding tank, releasing oxygen into the black water as the UHP dissolves to release urea and hydrogen peroxide that further reacts quickly to release oxygen into the black water.

While suitable enzymatic reaction with hydrogen peroxide via catalase present in the black water is likely to occur to a selected degree, it is further believed that the presence of the liberated ferric ion in black water solution will further react with and otherwise decompose the hydrogen peroxide present. According to present aspects, further contemplated oxygen-generating compounds to be included in the present compositions at least for the purpose of curtailing prospective bacterial oxygen generation include, for example, sodium percarbonate, an adduct of sodium carbonate and hydrogen peroxide, and having the formula 2NaCO₂CO₃·3H₂O. When sodium percarbonate dissolves in water (that can be present in the black water, for example), the adduct dissociates to form sodium carbonate and hydrogen peroxide. Catalase, a ubiquitous enzyme present, for example, in feces present in the black water, catalyzes the decomposition of hydrogen peroxide to water and oxygen. According to present aspects, the release of oxygen into the black water is believed to rapidly convert bacterial anaerobic growth (that form additional H₂S) to aerobic bacterial growth. The aerobic bacterial growth will significantly curtail or eliminate the future production of additional amounts of H₂S in the black water.

According to present aspects, the present compositions and methods realize a scavenging of existing H₂S in black water in black water holding tanks, and, optionally, the present compositions and methods can also convert conditions within the black water into aerobic conditions that can inhibit anerobic bacteria from prospectively producing additional amounts of H₂S in the black water. Maintaining a selected oxygen supply and oxygen concentration in the treated black water can increase and maintain the efficiency of inhibiting anerobic bacterial H₂S waste. It is realized that under acidic conditions, hydrogen peroxide in the presence of the reacting ferric aluminum citrate can observe the following reaction:

H₂O₂+2Fe²⁺+2H⁺- - - >2Fe²⁺+2H₂O.

By contrast, under basic condition in the presence of sodium carbonate the reaction can proceed as follows:

2Fe²⁺+2H₂O₂- - - 2Fe²⁺+2H₂O+O₂

According to present optional aspects, the present compositions release significant amounts of oxygen (produced in the black water through the addition of the present optional oxygen-releasing agents) that can dissolve in the black water and greet bacteria that can grow aerobically. As the volume of black water contents in a black water holding tank increases (e.g., through continued use of the holding tank, etc.) the newly added volume (that can include amounts of human waste) will “meet”, within the holding tank, a supply of available ferric ions in the black water that can begin to scavenge and neutralize additional H₂S sources added to the holding tank.

Further present aspects contemplate including one or more bacterial strains into the present compositions to further increase or assist in the digestion/decomposition of cellulose waste components (e.g., paper products, etc.) present in the black water in the holding tank. Present aspects are not limited by the further addition of such bacterial strains into the present compositions, as present aspects are primarily concerned with the breakdown, neutralization, elimination, etc., of H₂S in the black water, and, optionally, the control of additional H₂S generation by inhibiting the H₂S generating function of the bacteria anaerobically, and that can convert the environment within the black water to an aerobic environment as explained herein.

Experimental testing was conducted to determine preferred ferric-based salts for use in the present composition to achieve a selected degree of ferric ion release. In one example, it was determined that selected ferric ion release in the black water was accomplished through the incorporation of ferrous ammonium citrate (FAC) that contained approximately 17.7% Fe³⁺. In addition, according to further present aspects, it was determined that selected Fe³⁺ release from the ferrous ammonium citrate was improved by maintaining a pH within the black water (being treated by the present composition) at a pH of less than about 3.5. According to present aspects, the initial composition comprises amounts of citric acid at least for the purpose of maintaining a pH of treated black water at least than about 3.5 with acceptable pH ranging from about 3.0 to about 3.5, with the understanding that increased Fe³⁺ release was observed to occur at lower pH.

While present dosing of the present compositions contemplates including amounts of citric acid in the composition doses, the mechanisms within the present dynamic black water treatments and methods further contemplate the sequential addition of further amounts of citric acid over time to the black water under treatment within the holding tank to ensure that pH is buffered and otherwise maintained within a selected pH ranging from about 3.0 to about 3.5, with the citric acid understood to be a useful and complementary chemical agent to sustain desired and selected degrees of ferric-ion release for the purpose of achieving desired and selected H₂S removal, elimination and control relative to the black water contained in the holding tank.

### EXAMPLE 1

Ferric ion (Fe³⁺) release confirmation/impact of Citric Acid on Fe³⁺ release

Ferric ammonium citrate (FAC) was determined through bench experimentation to be a superior compound for use in the reduction and elimination of hydrogen sulfide gas concentration in an enclosed environment. Bench testing was conducted to evaluate citric acid on Fe3+ release into solution.

TABLE 1

| Ingredient Added | Solution A | | Solution B | | Solution C | |
|---|---|---|---|---|---|---|
| FAC | 0.2 | g | 0.2 | g | 0.2 | g |
| Citric Acid | 1.5 | g | 1.5 | g | 1.5 | g |
| Sodium Percarbonate | 0.2 | g | 0.1 | g | 0.05 | g |
| Deionized Water | 25 | g | 25 | g | 25 | g |

As shown in Table 1, potassium thiocyanate (KSCN) testing was conducted to determine Fe³⁺ ion release into solution from the ferric ammonium citrate and sodium percarbonate's effect on the release of the Fe³⁺ ion. As shown in Table 1, testing was done to determine any interfering effect of the oxygen-release/oxygenation agent present in the composition: sodium percarbonate. The three (3) Solutions A, B, C were made according to recorded constituent amounts. All solids were added concurrently, then mixed with added water until solids dissolved completely. Potassium thiocyanate testing was done using approximately 1 mL of KSCN measured with a 5 ml syringe and 1 ml of sample measured for each of Solutions A, B, C (also with 5 ml syringe). The three mixtures were gently agitated until color change was observed to be stable. After 48 hours, only Solution C having the lowest amount (0.05 g) exhibited a normal yellow color evidencing significant ferric ion release; while Samples A and B comprising 0.2 g and 0.3 g, respectively of sodium percarbonate remained clear. Adequate presence of Fe³⁺ ions was confirmed by KSCN testing with only Sample C appearing red in color.

To test the impact of citric acid on the release of Fe³⁺ ions in solution, progressive amounts of (e.g., additional amounts) of 1 g of citric acid were added to the Samples A, B, C. After 30 mins all 3 of Samples A, B, C turned red, evidencing an increased concentration of Fe³⁺ ions. Samples were then left overnight with no noticeable color change. Repeated KSCN testing evidenced no change in ferric ion (Fe³⁺) release. As additional amount of 3.5 g of citric acid was added to the Samples, A, B, C (to obtain a total amount of 5 g of citric acid in each Sample) and a continued increase in Fe³⁺ ion release was observed.

TABLE 2

| Ingredient | Sample A | | Sample B | | Sample C | | Sample D | |
|---|---|---|---|---|---|---|---|---|
| FAC | 0.2 | g | 0.2 | g | 0.2 | g | 0.2 | g |
| Na-Percarbonate | 0.05 | g | 0.05 | g | 0.05 | g | 0.05 | g |
| Citric Acid | 3 | g | 4 | g | 5 | g | 2 | g |
| Deion. Water | 25 | g | 25 | g | 25 | g | 25 | g |

Further testing was conducted, preparing the four (4) Samples—A, B, C, D—shown in Table 2, with the 4 Samples in Table 2 each comprising the same concentrations by weight of ferric ammonium citrate (0.2 g) and the same concentration by weight of sodium percarbonate (0.05 g). After 24 hours, all 4 Samples

### EXAMPLE 2

Ferric ammonium citrate (FAC) was determined through bench experimentation to be a superior compound for use in the reduction and elimination of hydrogen sulfide gas concentration in an enclosed environment. Bench testing was conducted to evaluate container conditions of H₂S in samples in response to present additives comprising stated constituent amounts.

Leakproof 250 mL Pyrex glass bottles were selected to test ferric-ion presence indicating a proven ferric-ion release into solution from the ferric ion-releasing compound under evaluation. A premade 0.4% hydrogen sulfide solution was added to the Pyrex bottle. Sodium percarbonate was tested for use as an oxygen-generating compound, with experimentation believed to reveal the sodium percarbonate breakdown into solution revealing an impact of the sodium percarbonate (as pH rose) on Fe³⁺ ion release from the ferrous ammonium citrate. Additional amounts of citric acid were added to return pH to a selected level below 3.5. Released Fe³⁺ ion was confirmed by KSCN testing as described herein. See Table 3.

TABLE 3
Sample Compositions

| | “Low” | | “High” | | (½ CA)- | |
|---|---|---|---|---|---|---|
| Ingredient | Conc.-“A” | | Conc.-“B” | | “C” | |
| FAC | 0.2 | g | 7.8 | g | 7.8 | g |
| Citric Acid | 2 | g | 78 | g | 39 | g |
| Water | 197.8 | g | 190.2 | g | 190.2 | g |

As shown in Table 3, Samples “A”, “B”, and: C” were prepared to create “low” and “high” concentrations of present compositions and were tested over to determine H₂S concentration over time. The high concentration of citric acid (78 g) in Sample “B” exceeded the vessel volume. Sample “B” was discarded and a “½” Sample “C” was prepared using 39 g of citric acid. Over a period of 48 hours the added amount of citric acid was determined to be highly effective as H₂S levels were maintained at less than 3 ppm, evidencing adequate amounts of Fe3+ remained in solution to neutralize the H₂S in solution.

As stated herein, the present compositions can be provided in solid or liquid form and delivered into black water in a vehicle black water holding tank in a selected amount that can be an effective pre-dosed amount by any suitable delivery method. Suitable delivery methods can include delivery of the composition in solid form as pellets or powders that can be delivered from a bulk source via, for example, a scoop.

In other examples, the composition can be pre-dosed into a solid form that can include an effective amount in, for example, larger pellets or “briquettes”. In a further example, if a liquid form is desired, the present compositions can be dissolved in an aqueous solution and pre-dosed into an effective amount and delivered from an opened packet or pouch, etc. In still further examples, effective amounts of the present composition can be pre-dosed into a pod or other deliverable form where the pre-dosed effective amount of the composition that can be solid or liquid is encapsulated in an encapsulation that is delivered into a black water volume of a black water holding tank, with the encapsulation configured to dissolve and release the composition from the encapsulation. Such solid or liquid composition encapsulation can be configured to dissolve and release the composition content in a short duration in the black water ranging from one minute up to a few minutes. In another example, such solid or liquid composition encapsulation can be configured to dissolve and release the composition content into a black water volume in a short duration of about 1.5 minutes.

In another example, black water holding tanks that are empty, near empty, or that contain very low volumes of black water can be “pre-treated” with the present compositions. In this example, the present composition is added before black water is introduced to the holding tank. Such pre-treatment allows the composition to react with “fresh” black water from the moment the black water enters the holding tank, and the composition can scavenge hydrogen sulfide as it is formed. Optionally, the oxygen-generating compounds can be introduced to the black water to generate amounts of oxygen to forestall the growth of anerobic bacteria and production of hydrogen sulfide in the newly accumulating black water.

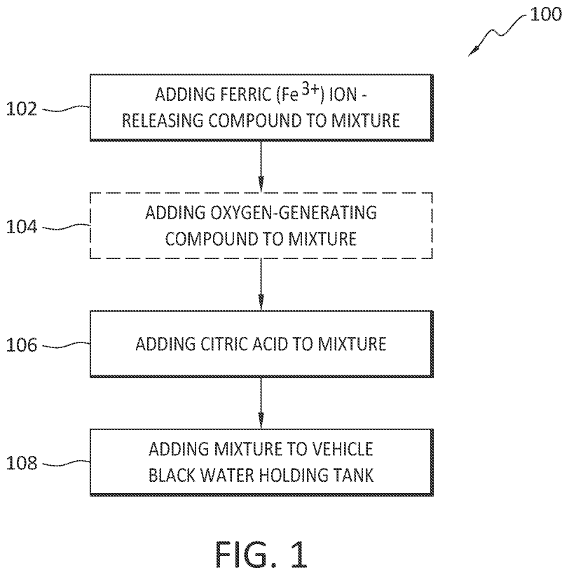

FIGS. 1-5 are flowcharts outlining present methods in non-limiting fashion. According to present aspects, FIG. 1 is flowchart outlining a method 100 for treating wastewater in a recreational vehicle wastewater holding tank, with the method including adding to a vehicle black water holding tank containing black water, a composition, with the composition including a ferric ion-releasing compound (adding 102 the ferric ion-releasing compound), and citric acid (adding 106 citric acid). As outlined in FIG. 1, method 100 includes adding 108 the composition mixture to a black water holding tank. FIG. 1 further includes the optional step of adding 104 an oxygen-generating compound to the present mixtures that include the present compositions.

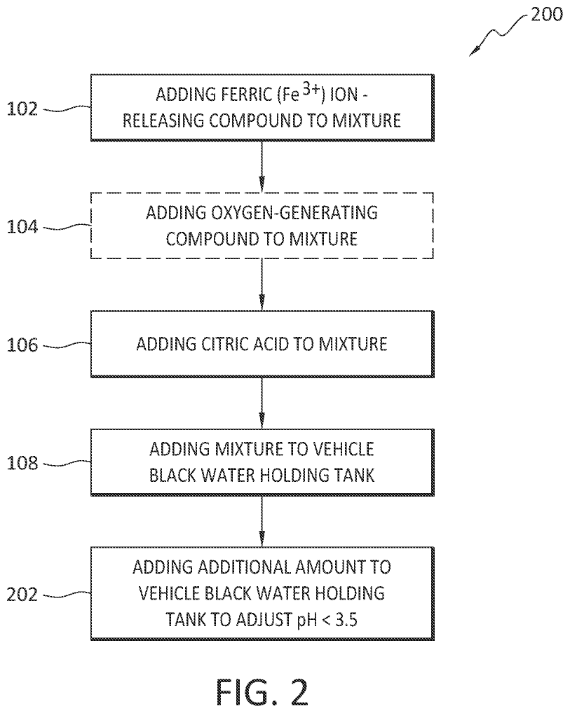

According to present aspects, FIG. 2 outlines a method 200 that includes the steps outlined in method 100 (shown in FIG. 1) and further includes adding 202 additional amounts of citric acid to the black water holding tank, with the additional amounts of citric acid added as additional citric acid dosages to adjust a blackwater pH and/or to maintain a black water pH at a pH of less than about 3.5, and preferably with the pH ranging from 3.0 to 3.5.

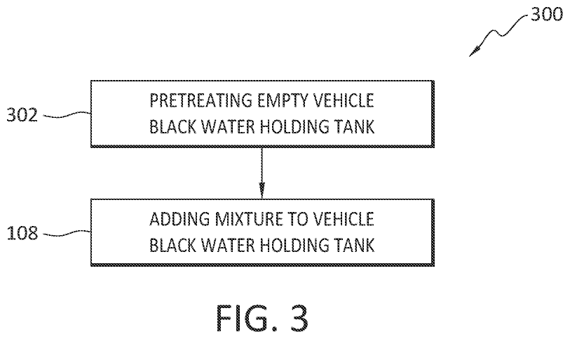

FIG. 3 is a flowchart outlining a method 300, according to present aspects, with method 300 including pretreating 302 an empty vehicle black water holding tank, with method 300 further including adding 108 the composition mixture described herein to a black water holding tank.

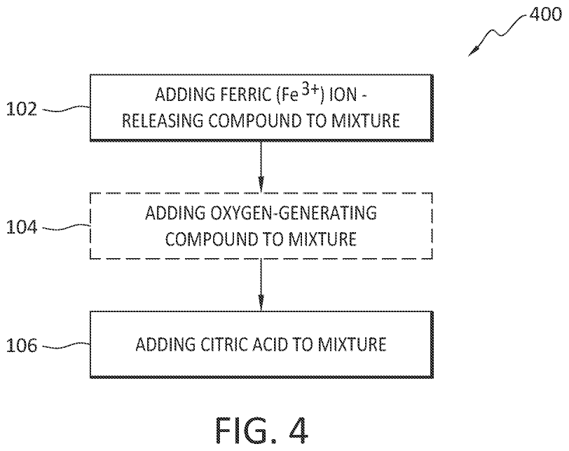

FIG. 4 is a flowchart outlining a method 400 for making the present compositions described herein, according to present aspects, with method 400 including adding 102 ferric ion-releasing compound, and adding 106 citric acid to form a mixture according to the present composition. Method 400 further includes the optional step of adding 104 an oxygen-generating compound to the present mixtures that include the present compositions. As set forth herein, in one example, the relative wt % amount of ferric ion-releasing compounds to citric acid is present in the composition in a relative ratio of 2:1. In another example, the ferric iron-releasing compound is present in the composition in an amount ranging from about 60 wt % to about 66 wt %; and the citric acid is present in the composition in an amount ranging from about 34 wt % to about 40 wt %

The methods 100, 200, 300, 400 as shown in FIGS. 1, 2, 3, 4, respectively, are understood to employ the present compositions described herein.

The term “substantially” as used herein means that a particular characteristic,

parameter, or value does not need to be exactly achieved. Rather, deviations or variations, including, for example, tolerances, measurement error, measurement accuracy limitations, and other factors known to those skilled in the field, may occur in amounts that do not preclude the effect that the characteristic was intended to provide.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A composition for treating a vehicle black water holding tank, the composition comprising:
a ferric ion-releasing compound; and
citric acid; and
a ferric ion-releasing compound in an amount ranging from about 60% wt% to about 66 wt %; and
citric acid in an amount ranging from about 34 wt % to about 40 wt %. wherein said composition in solution is configured to scavenge hydrogen sulfide from a black water holding tank in a vehicle.

2. The composition of claim 1, wherein the composition comprises wherein said ferric ion-releasing compound and citric acid are provided in the composition in a wt % ratio of 2:1.

3. The composition of claim 1, wherein the ferric-ion producing compound is ferric ammonium citrate.

4. The composition of claim 1, wherein the composition in solution in a black water tank maintains a pH ranging from about 3.0 to about 3.5.

5. The composition of claim 4, wherein the composition in a black water solution in black water in black water in a black water holding tank maintains a hydrogen sulfide concentration in black water ranging from about 5 ppm to about 10 ppm when a black water holding tank solution maintains a pH ranging from about 3.0 to about 3.5.

6. The composition of claim 1, wherein the ferric ion-releasing compound comprises at least one of ferric sulfate, ferric nitrate and ferric ammonium citrate.

7. The composition of claim 1, wherein the ferric ion-releasing compound comprises ferric ammonium citrate.

8. The composition of claim 1, wherein the composition is in a liquid mixture form.

9. The composition of claim 1, wherein the composition is a solid mixture form.

10. The composition of claim 8, wherein the composition is encapsulated in a water soluble encapsulation.

11. The composition of claim 9, wherein the composition is encapsulated in a water soluble encapsulation.

12. A pre-dosed treatment for scavenging hydrogen sulfide from black water contained within a black water holding tank in a vehicle, the pre-dosed treatment comprising:
a black water treatment composition, said black water treatment composition comprising:
a ferric ion-releasing compound in an amount ranging from about 60 wt % to about 66 wt %; and
citric acid in an amount ranging from about 34 wt % to about 40 wt %.

13. The pre-dosed treatment of claim 12, wherein said ferric ion-releasing compound and citric acid are provided in the composition in a wt % ratio of 2:1.

14. The pre-dosed treatment of claim 12, wherein the composition is in liquid form The pre-dosed treatment of claim 12, wherein the composition is a solid.

15. The pre-dosed treatment of claim 12, wherein the composition is in pellet form.

16. The pre-dosed treatment of claim 12, wherein the composition is a time-released composition.

17. The pre-dosed treatment of claim 12, wherein the pre-dosed treatment further comprises a pre-dosed encapsulated volume of the treatment composition.

18. The pre-dosed treatment of claim 12, wherein the pre-dosed encapsulated volume of the treatment composition is released from a water soluble encapsulation.

19. The pre-dosed treatment of claim 12, wherein the pre-dosed treatment is a solid.

20. A method for treating wastewater in a recreational vehicle wastewater holding tank, the method comprising:
adding to a vehicle black water holding tank containing black water a composition, said composition comprising:
a ferric ion-releasing compound in an amount ranging from about 60 wt % to about 66 wt %;
citric acid in an amount ranging from about 34 wt % to about 40 wt %; and
adding additional amounts of citric acid to the black water holding tank to maintain a pH in the black water ranging from about 3.0 to about 3.5.
